(19) United States
(12) Patent Application Publication
(10) Pub. No.: US 2010/0124187 A1
(43) Pub. Date: May 20, 2010

(54) Communication system and method of communicating signals

(76) Inventors: Glenn A. Walker, Greentown, IN (US); Eric A. Dibiaso, Kokomo, IN (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/313,474

(22) Filed: Nov. 20, 2008

(51) Int. Cl. H04B 7/185; H04L 27/28

(52) U.S. Cl. 370/316; 375/260

(57) ABSTRACT

A communication system and method are provided, wherein the system includes a first satellite orbiting in a first orbital path that communicates a first signal having a first content at a transmitting frequency while at a first elevation angle, and a second satellite orbiting in a second orbital path that communicates a second signal having a second content at the transmitting frequency while at a second elevation angle, wherein the first elevation angle is greater than the second elevation angle. The system further includes at least one terrestrial repeater that communicates a hierarchical modulated signal, wherein a hierarchical primary of the hierarchical modulated signal corresponds to the second signal communicated from the second satellite, and a hierarchical secondary of the hierarchical modulated signal corresponds to the first signal communicated from the first satellite, such that the first and second signals are communicated at the same transmitting frequency.

### TECHNICAL FIELD

The present invention generally relates to a communication system and method of communicating signals, and more particularly, a communication system and method of communicating signals having different content on the same frequency.

### BACKGROUND OF THE INVENTION

Generally, vehicles can be equipped with satellite radio receivers as an alternative to, or in combination with, common traditional terrestrial radio receivers. Additionally, satellite radio receivers can be used in places other than vehicles, such as handheld devices. Generally, satellite radio systems are designed, such that the receiver receives a satellite radio frequency (RF) signal from a satellite and a terrestrial RF signal from a terrestrial repeater or a transponder, which typically provides system redundancy.

The current systems in operation in the U.S. generally use double redundant information to enable high signal availability to receivers. These systems typically use time and spatial redundancy for the satellite signals, such that the signal is transmitted from two sources. Typically, in urban areas, terrestrial repeaters can provide a third signal source. Generally, such systems use different frequencies for the satellite signal and the terrestrial repeater signal. This architecture generally reduces the bandwidth efficiency of the system by one-third (⅓), while increasing overall availability.

Due to current European regulations, the European satellite radio system currently has twenty-three (23) contiguous frequencies across a forty megahertz (40 MHz) frequency band. Generally, there are seven (7) frequencies that are designated for hybrid systems only, which include the transmission of the satellite RF signal and the terrestrial RF signal. Typically, the current European satellite radio system is constrained to frequency bandwidths of 1.712 MHz.

With multiple satellites, it can be a problem to receive signals from one satellite and then receive signals from another satellite at the same frequency due to the differing locations of the satellites with respect to the receiver. One exemplary system generally includes a receiver having an antenna element that receives signals at the same frequency, wherein the antenna element has a very high gain (e.g., beam steered). By including such a high gain antenna element, the signals can be separated, along with polarization. Typically, such an exemplary system transmits satellite television signals that are received by the antenna element.

Generally, a satellite that communicates a signal to a receiver from a service provider transmits the signal at a particular frequency, and a second satellite communicates another signal to another receiver from another service provider, wherein the signal is transmitted from the second satellite at another particular frequency different that the frequency used by the first satellite. Thus, two frequencies of the frequency spectrum are utilized to transmit different content. Further, if additional signals are to be transmitted with different content at different frequencies, more frequencies of the limited frequency spectrum are occupied, and cannot be utilized for other uses.

### SUMMARY OF THE INVENTION

According to one aspect of the present invention, a communication system includes a first satellite orbiting in a first orbital path that communicates a first signal having a first content at a transmitting frequency while at a first elevation angle, a second satellite orbiting in a second orbital path that communicates a second signal having a second content at the transmitting frequency while at a second elevation angle, wherein the first elevation angle is greater than the second elevation angle, and at least one terrestrial repeater that communicates a hierarchical modulated signal, wherein a hierarchical primary of the hierarchical modulated signal corresponds to the second signal communicated from the second satellite, and a hierarchical secondary of the hierarchical modulated signal corresponds to the first signal communicated from the first satellite, such that the first and second signals are communicated at the same transmitting frequency.

According to another aspect of the present invention, a communication system includes a highly elliptical orbiting (HEO) satellite orbiting in a highly elliptical orbiting path that communicates a first signal having a first content at a transmitting frequency while at a first elevation angle, a geo-stationary (GEO) satellite orbiting in a GEO orbital path that communicates a second signal having a second content at a transmitting frequency while at a second elevation angle, wherein the first elevation angle is greater than the second elevation angle, and at least one terrestrial repeater that communicates a hierarchical modulated signal, wherein a hierarchical primary of the hierarchical modulated signal corresponds to the second signal communicated from the GEO satellite, and a hierarchical secondary of the hierarchical modulated signal corresponds to the first signal communicated from the HEO satellite, such that the first and second signals are communicated at the same frequency.

According to yet another aspect of the present invention, a method of communicating signals having different content on the same transmitting frequency includes the steps of communicating a first signal having a first content at a transmitting frequency from a first satellite at a first elevation angle, communicating a second signal having a second content at the transmitting frequency from a second satellite at a second elevation angle, wherein the second elevation angle is lower than the first elevation angle, and communicating a hierarchical modulated signal from at least one terrestrial repeater, wherein a hierarchical primary of the hierarchical modulated signal corresponds to the second signal communicated from the second satellite, and a hierarchical secondary of the hierarchical modulated signal corresponds to the first signal communicated from the first satellite, such that the first and second signals are communicated at the same frequency.

### BRIEF DESCRIPTION OF THE DRAWINGS

The present invention will now be described, by way of example, with reference to the accompanying drawings, in which:

FIG. 1 is an environmental view of a communications system that includes a communication device, in accordance with one embodiment of the present invention;

FIG. 2 is a diagram illustrating an exemplary orbital path of highly elliptical orbiting satellites, in accordance with one embodiment of the present invention;

FIG. 3 is a chart illustrating QPSK signals transmitted from satellites having different orbital paths, in accordance with one embodiment of the present invention;

FIG. 4 is a block diagram of a communication device, in accordance with one embodiment of the present invention;

FIG. 5 is a diagram illustrating the reception characteristics of signals having different polarizations and being received at different reception elevation angles with respect to at least one antenna element, in accordance with one embodiment of the present invention; and

FIG. 6 is a flow chart illustrating a method of communicating signals having different content on the same transmitting frequency, in accordance with one embodiment of the present invention.

### DESCRIPTION OF PREFERRED EMBODIMENTS

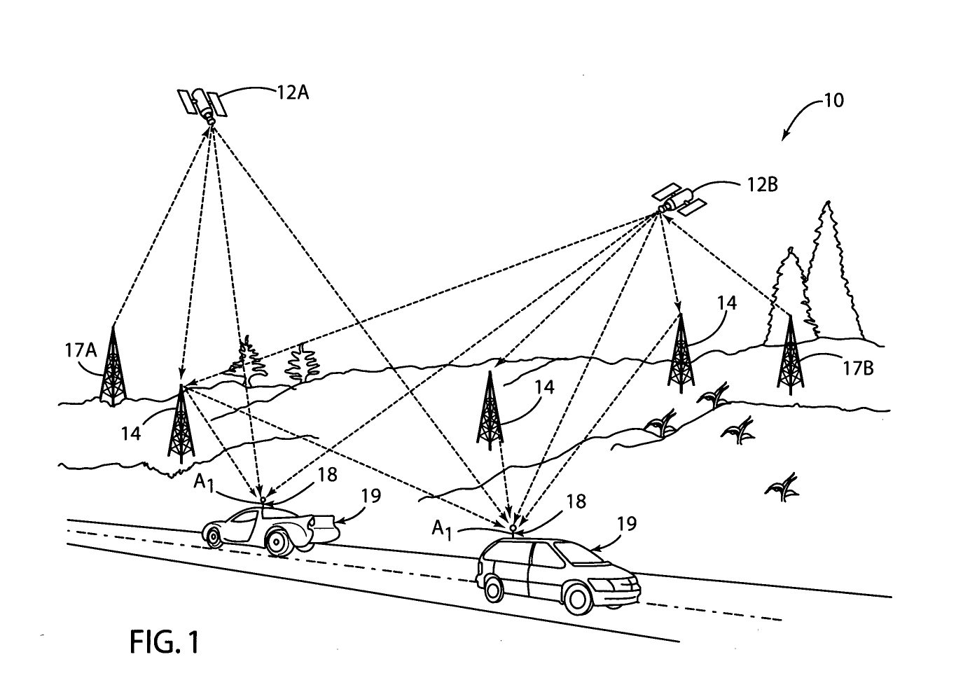

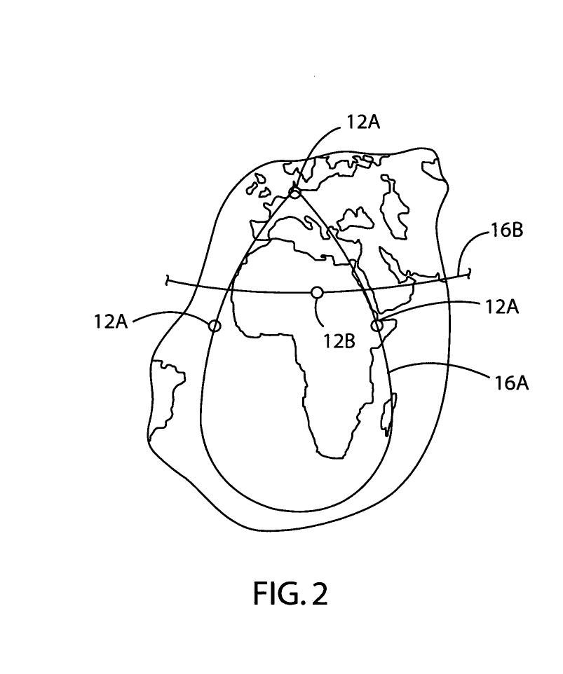

In regards to both FIGS. 1 and 2, a communication system is generally shown at reference identifier 10. The communication system 10 includes a first satellite 12A, a second satellite 12B, and at least one terrestrial repeater 14 (FIG. 1). The first satellite 12A orbits in a first orbital path 16A, as shown in FIG. 2, and communicates a first signal having a first content at a transmitting frequency while at a first elevation angle. The second satellite 12B orbits in a second orbital path 16B, as shown in FIG. 2, and communicates a second signal having a second content at the transmitting frequency while at a second elevation angle. Typically, the first elevation angle is greater than the second elevation angle. Also, the first content is different than the second content, such that the first signal communicated from the first service provider 17A differs from a second signal communicated from a second service provider 17B, according to one embodiment.

The terrestrial repeater 14 communicates a hierarchical modulated signal, wherein a hierarchical primary of the hierarchical modulated signal corresponds to the second signal communicated from the second satellite 12B, and a hierarchical secondary of the hierarchical modulated signal corresponds to the first signal communicated from the first satellite 12A, such that the first and second signals are communicated at the same transmitting frequency, as described in greater detail herein.

The communication system 10 typically includes a receiver, generally indicated at 18, in communication with one of the first and second satellites 12A, 12B, wherein the receiver 18 is configured to reject the signal communicated from the other of the first and second satellites 12A, 12B. Thus, the first service provider 17A can provide content utilizing the first satellite 12A, while the second service provider 17B can provide different content utilizing a second satellite 12B, wherein the receiver 18 is configured to receive content from one of the service providers 17A, 17B. Therefore, multiple service providers (17A,17B, . . . 17_{N}) can provide different content utilizing the same transmitting frequency, and thus, expanding the amount of content that can be communicated in the frequency spectrum. According to one embodiment, the receiver 18 can be used with a vehicle generally indicated at 19.

According to one embodiment, the receiver 18 rejects the signal communicated from the other of the first and second satellites 12A, 12B as a function of the first and second elevation angles. By way of explanation and not limitation, the first satellite 12A can be a highly elliptical orbiting (HEO) satellite having an elliptical orbiting path (e.g., the first orbital path 16A), and the second satellite 12B can be a geo-stationary (GEO) satellite having an orbital path substantially along the equator (e.g., the second orbital path 16B) (FIG. 2). In such an embodiment, there can be three first satellites 12A orbiting in the HEO orbital path 16A, wherein the first satellite 12A that is in the high position above the reception area is transmitting the signal, while the other satellites in the HEO orbital path 16A are turned off, so that the first satellite 12A transmitting the first signal has a higher elevation angle than the other satellites 12A in the HEO orbital path 16A and the transmitting second satellite 12B in the GEO orbital path 16B.

Due to the GEO orbital path 16B having a lower elevation angle for communicating the signal, typically more terrestrial repeaters 14 are utilized to retransmit the signal than the number of terrestrial repeaters 14 that are utilized for retransmitting the signal retransmitted from the first satellite 12A. Typically, the signals transmitted from the second satellite 12B in the GEO orbital path 16B have more obstructions in the signal path, such as mountainous terrain and buildings in urban areas, which do not have such an effect on the signal transmitted from the first satellite 12A in the HEO orbital path 16A, which is at the higher elevation angle.

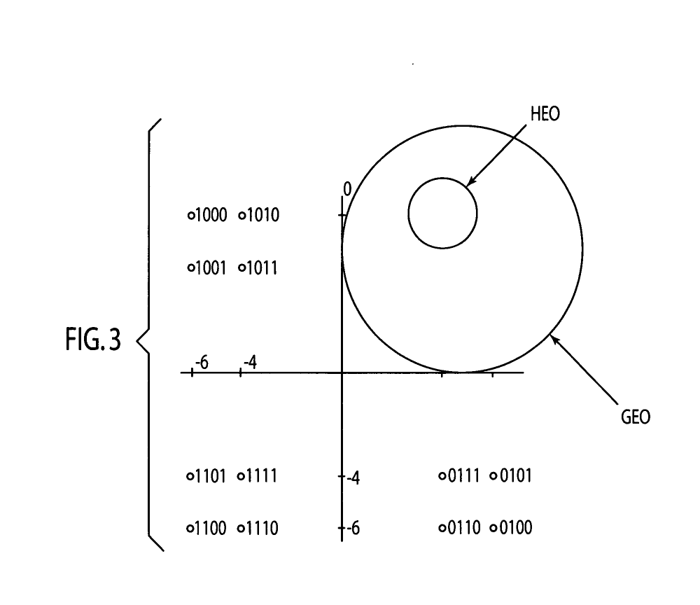

Since more terrestrial repeaters 14 are typically utilized to retransmit the signal from the second satellite 12B than the first satellite 12A, due to the lower elevation angle of the second satellite 12B, the hierarchical primary of the hierarchical modulated signal corresponds to the second signal communicated from the second satellite 12B, and the hierarchical secondary of the hierarchical modulated signal corresponds to the first signal communicated from the first satellite 12A. According to one embodiment, the hierarchical modulated signal communicated from the terrestrial repeater 14 appears as a sixteen (16) quadrature amplitude modulation (QAM) orthogonal frequency-division multiplexing (OFDM) constellation (FIG. 3). However, it should be appreciated by those skilled in the art that other suitable types of hierarchical modulated signals can be utilized for retransmission of signals from the first and second satellites 12A, 12B and the terrestrial repeater 14.

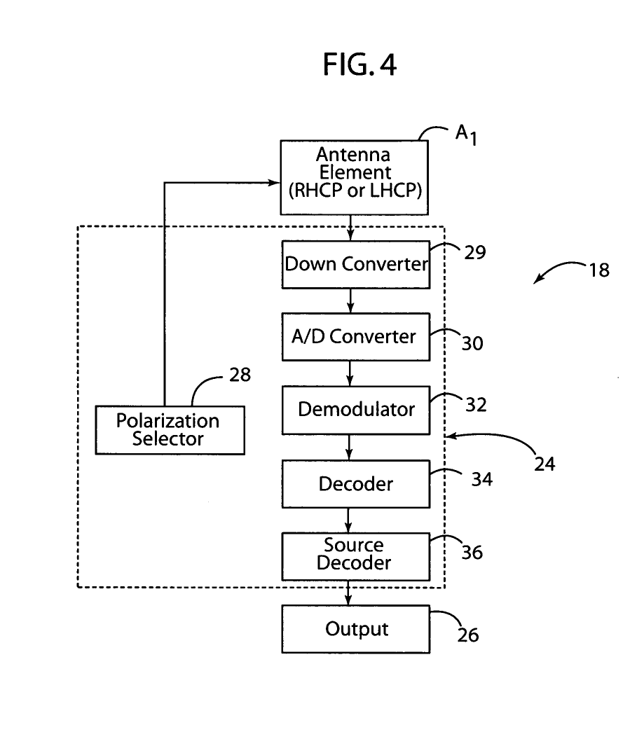

In regards to both FIGS. 1 and 4, the receiver 18 can include at least one antenna element A₁ and circuitry generally indicated at reference identifier 24 (FIG. 4) that is in communication with the antenna element A₁, according to one embodiment. Exemplary communication systems having exemplary antenna elements are disclosed in U.S. patent application Ser. No. ______ (Attorney Docket No. DP-317186), entitled “COMMUNICATIONS SYSTEM AND METHOD OF COMMUNICATING DATA,” and U.S. patent application Ser. No. ______ (Attorney Docket No. DP-317237), entitled “RECEIVER DEVICE AND METHOD OF RECEIVING A PLURALITY OF SIGNALS,” the entire disclosures being hereby incorporated herein by reference.

For purposes of explanation and not limitation, in operation, the antenna element A₁ receives at least the first signal having a first polarization, while rejecting the second signal received from the second elevation angle having a second polarization, and the circuitry 24 is configured to process and emit an output 26 based upon the received first signal. In such an embodiment, the antenna element A₁, the circuitry 24, or a combination thereof, rejects one of the first and second signals as a function of the elevation angle and the polarization of the signal. Exemplary polarizations that may be utilized are right hand circular polarization (RHCP), left hand circular polarization (LHCP), linear polarization, the like, or a combination thereof, according to one embodiment. It should be appreciated by those skilled in the art that other suitable polarizations may be utilized when transmitting one or more signals.

Generally, an elevation angle can be the angle that a signal is received from the satellite (e.g., the first and second satellites 12A, 12B) with respect to the antenna element A₁, according to one embodiment. By way of explanation and not limitation, the output 22 can be a video output, an audio output, the like, or a combination thereof. It should be appreciated by those skilled in the art that the at least one antenna element can include any number of suitable antenna elements (i.e., A₁,A₂, . . . A_{N},).

The receiver 18 can further include a polarization selector 28 in communication with the antenna element A₁, wherein the polarization selector 28 alters the polarization of the antenna element A₁, such that the antenna element A₁ is adapted to receive either the first signal having the first polarization received from the first elevation angle or the second signal having the second polarization received from the second elevation angle. Thus, a single receiver 18 can be configured to receive different content provided from different source providers 17A, 17B.

Additionally, the receiver 18 can include at least one down converter 29 and at least one analog-to-digital (A/D) converter 30. Typically, the down converter 29 down converts or reduces a frequency of a radio frequency (RF) signal that is received by the antenna element A₁ to a lower frequency for transmission through the receiver 18, and the A/D converter 30 converts the analog signal received by the antenna element A₁ to a digital signal. The receiver 18 can further include a demodulator 32 in communication with A/D converter 30 that is configured to demodulate the signal received by the antenna element A₁. Further, a decoder 34 can be in communication with the demodulator 32 and be configured to decode an output received from the demodulator 32, and a source decoder 36 can receive a decoded output of the decoder 34, such that the output 26 is emitted based upon the signal received by the antenna element A₁.

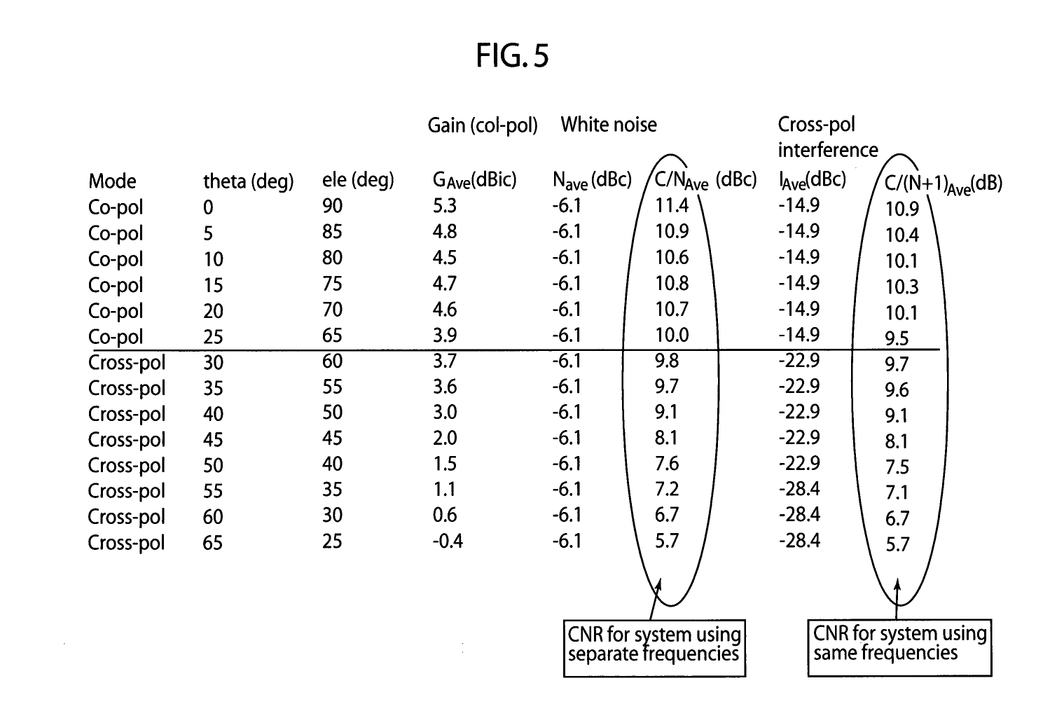

With respect to FIG. 5, this figure illustrates reception characteristics of signals having different polarizations and having different reception angles with respect to the at least one antenna element (A₁,A₂, . . . A_{N}).

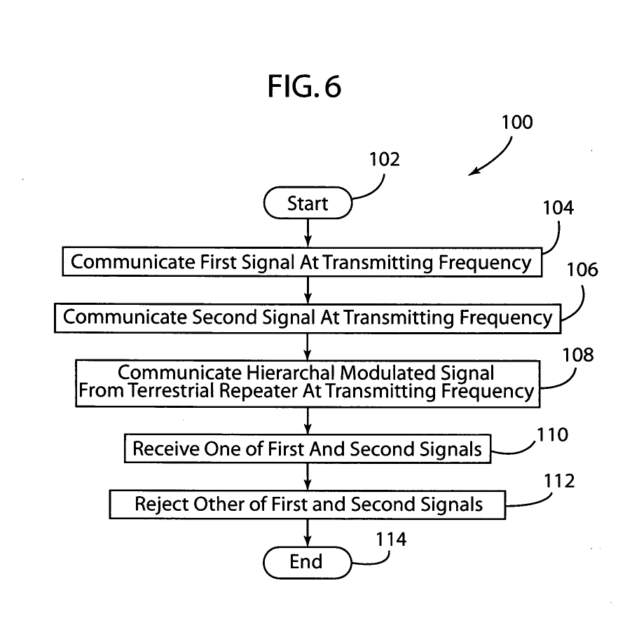

In regards to FIGS. 1, 2, and 6, a method of communicating signals having different content on the same transmitting frequency is generally shown in FIG. 6 at reference identifier 100. The method 100 starts at step 102, and proceeds to step 104, wherein a first signal is communicated at a transmitting frequency. At step 106, a second signal is communicated at the transmitting frequency. Typically, the first and second signals have different content and are transmitted at different elevation angles, but are transmitted at the same transmitting frequency.

The method 100 then proceeds to step 108, wherein a hierarchical modulated signal is communicated from the terrestrial repeater 14 at the transmitting frequency. At step 110, one of the first and second signals is received by the receiver 18. At step 112, the other of the first and second signals is rejected by the receiver 18. Typically, the other of the first and second signals is rejected based upon the elevation angle of the transmitted signal, the polarization of the transmitted signal, or a combination thereof. The method 100 then ends at step 114.

Advantageously, the communication system 10 and method 100 allow for different service providers to provide different content on first and second signals, which are transmitted at the same frequency, and thus, expanding the use of the frequency spectrum. Since the first and second signals are communicated from first and second satellites 12A, 12B, respectively, the signals can be rejected by the receiver 18 based upon the elevation angle. Thus, the signal to be rejected causes minimal interference to the signal that is to be received to produce the output 26. It should be appreciated by those skilled in the art that initial or alternative advantages may be present from the communication system 10 and method 100. It should further be appreciated by those skilled in the art that the above components can be combined in additional or alternative ways.

The above description is considered that of preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims, as interpreted according to the principles of patent law, including the doctrine of equivalents.

1. A communication system comprising:
a first satellite orbiting in a first orbital path that communicates a first signal having a first content at a transmitting frequency while at a first elevation angle;
a second satellite orbiting in a second orbital path that communicates a second signal having a second content at said transmitting frequency while at a second elevation angle, wherein said first elevation angle is greater than said second elevation angle; and
at least one terrestrial repeater that communicates a hierarchical modulated signal, wherein a hierarchical primary of said hierarchical modulated signal corresponds to said second signal communicated from said second satellite, and a hierarchical secondary of said hierarchical modulated signal corresponds to said first signal communicated from said first satellite, such that said first and second signals are communicated at the same said transmitting frequency.

2. The communication system of claim 1 further comprising a receiver in communication with one of said first and said second satellites, wherein said receiver is configured to reject said signal communicated from the other of said first and second satellites.

3. The communication system of claim 2, wherein said receiver rejects said signal communicated from the other of said first and second satellites as a function of said first and second elevation angles.

4. The communication system of claim 2, wherein said receiver is used with a vehicle.

5. The communication system of claim 1, wherein said first signal and said second signal have different polarizations.

6. The communication system of claim 1, wherein said first satellite is a highly elliptical orbiting (HEO) satellite.

7. The communication system of claim 1, wherein said second satellite is a geo-stationary (GEO) satellite.

8. The communication system of claim 1, wherein said hierarchical modulated signal communicated from said terrestrial repeater appears as a sixteen (16) quadrature amplitude modulation (QAM) orthogonal frequency-division multiplexing (OFDM) constellation.

9. A communication system:
a highly elliptical orbiting (HEO) satellite orbiting in a highly elliptical orbiting path that communicates a first signal having a first content at a transmitting frequency while at a first elevation angle;
a geo-stationary (GEO) satellite orbiting in a GEO orbital path that communicates a second signal having a second signal at a transmitting frequency while at a second elevation angle, wherein said first elevation angle is greater than said second elevation angle; and
at least one terrestrial repeater that communicates a hierarchical modulated signal, wherein a hierarchical primary of said hierarchical modulated signal corresponds to said second signal communicated from said GEO satellite, and a hierarchical secondary of said hierarchical modulated signal corresponds to said first signal communicated from said HEO satellite, such that said first and second signals are communicated at the same said frequency.

10. The communication system of claim 9 further comprising a receiver in communication with one of said first and said second satellites, wherein said receiver is configured to reject said signal communicated from the other of said first and second satellites.

11. The communication system of claim 10, wherein said receiver rejects said signal communicated from the other of said first and second satellites as a function of said elevation angles.

12. The communication system of claim 10, wherein said receiver is used with a vehicle.

13. The communication system of claim 9, wherein said first signal and said second signal have different polarizations.

14. The communication system of claim 9, wherein said hierarchical modulated signal communicated from said terrestrial repeater appears as a sixteen (16) quadrature amplitude modulation (QAM) orthogonal frequency-division multiplexing (OFDM) constellation.

15. A method of communicating signals having different content on the same transmitting frequency, said method comprising:
communicating a first signal having a first content at a transmitting frequency from a first satellite at a first elevation angle;
communicating a second signal having a second content at said transmitting frequency from a second satellite at a second elevation angle, wherein said second elevation angle is lower than said first elevation angle; and
communicating a hierarchical modulated signal from at least one terrestrial repeater, wherein a hierarchical primary of said hierarchical modulated signal corresponds to said second signal communicated from said second satellite, and a hierarchical secondary of said hierarchical modulated signal corresponds to said first signal communicated from said first satellite, such that said first and second signals are communicated at the same said frequency.

16. The method of communicating signals of claim 15 further comprising the steps of:
receiving one of said first and second signals; and
rejecting the other of said first and second signals as a function of said elevation angles.

17. The method of communicating signals of claim 15, wherein said first and second signal have different polarizations.

18. The method of communicating signals of claim 15, wherein said first satellite is a highly elliptical orbiting (HEO) satellite.

19. The method of communicating signals of claim 15, wherein said second satellite is a geo-stationary (GEO) satellite.

20. The method of communicating signals of claim 15, wherein said hierarchical modulated signal communicated from said terrestrial repeater appears as a sixteen (16) quadrature amplitude modulation (QAM) orthogonal frequency-division multiplexing (OFDM) constellation.
